(19) United States
(12) Patent Application Publication
(10) Pub. No.: US 2008/0040961 A1
(43) Pub. Date: Feb. 21, 2008

(54) Banner Equipped with Elastic Frame

(76) Inventors: Jong-Hyun Hwang, Incheon (KR); Ju-Yong Song, Incheon (KR)

Correspondence Address: IPLA P.A., 3580 WILSHIRE BLVD., 17TH FLOOR, LOS ANGELES, CA, 90010, US

(21) Appl. No.: 11/571,292

(22) PCT Filed: Jun. 29, 2005
(86) PCT No.: PCT/KR05/02042

§ 371 Date: Dec. 26, 2006

(30) Foreign Application Priority Data
Jun. 29, 2004 (KR) 10-2004-0049333

(51) Int. Cl. G09F 15/00

(52) U.S. Cl. 40/610

(57) ABSTRACT

Disclosed herein is a banner equipped with an elastic frame. The banner equipped with the elastic frame includes: a banner printed with advertising contents; a frame receiving part disposed on the edge of the banner; a frame inserted into the frame receiving part and forming the exterior shape of the banner using its elasticity; and pole mounting portions disposed on the frame receiving part at a predetermined interval for mounting poles of a banner supporter for supporting the banner, wherein the frame is an elastic body, and its both ends are not connected integrally in a loop shape but separated from each other.

### TECHNICAL FIELD

The present invention relates to a structure of a banner for advertisement.

In other words, the present invention relates to a banner equipped with an elastic frame which is inserted into a frame receiving part provided to the edge of the banner and forms the exterior shape of the banner using its elasticity.

### BACKGROUND ART

In general, a banner on which various advertising words or event contents are printed is manufactured in various forms and mounted on the roadside in a horizontal direction or a vertical direction.

To mount the banner in the vertical direction, as shown in FIG. 1, a supporting rod stands vertically, a pair of horizontal bars are mounted in such a way as to maintain an interval corresponding to a vertical length of the banner mounted along a longitudinal direction of the supporting rod, and the top and bottom of the banner are caught and fixed to the horizontal bars. At this time, the banner has support frames respectively provided to the top and bottom of the banner and corresponding to a horizontal width of the banner.

However, in the banner mounted in the vertical direction, the top and bottom of the banner are fixed on the horizontal bars, but just caught to the supporting frames disposed on the top and bottom of the banner, and so, its fixed condition is not firm and strong.

Therefore, the conventional banner mounted in the vertical direction has several disadvantages in that accidents may occur, an advertising effect of the banner is deteriorated, and beauty of a city is injured when it blows hard and the banner is separated from the horizontal bars and flaps in the wind.

Furthermore, the supporting rod shall be fixed and mounted on the ground, and so, the banner is restricted in installation place and requires lots of money to install.

To solve the above problems, a banner holder without using a separate supporting rod is proposed.

The banner holder shown in FIG. 2 includes a supporting member filled with water like a water bucket, a vertical member standing on the supporting member, upper poles for supporting the top of the banner and lower poles for supporting the bottom of the banner.

The banner mounted on the holder does not have additional frame, and is tightly and firmly supported by elasticity of the upper and lower poles.

Therefore, the banner can keep a plane state by being tightly pulled in four directions. However, the banner has a disadvantage in that the advertising effect is deteriorated since people can see the banner, on which advertising contents are printed, only at a side.

### DISCLOSURE OF INVENTION

Technical Solution

Accordingly, it is an object of the present invention to provide a banner equipped with an elastic frame, which does not need a separate supporting rod fixed and mounted on the ground.

It is another object of the present invention to provide a banner equipped with an elastic frame, which can be firmly and safely installed by a holder.

It is a further object of the present invention to provide a banner equipped with an elastic frame, which can maintain a three-dimensional form in a state where the banner is installed.

It is a still further object of the present invention to provide a banner equipped with an elastic frame, which can provide various shapes.

To achieve the above object, the present invention provides a banner equipped with an elastic frame including: a banner printed with advertising contents; a frame receiving part disposed on the edge of the banner; a frame inserted into the frame receiving part and forming the exterior shape of the banner using its elasticity; and pole mounting portions disposed on the frame receiving part at a predetermined interval for mounting poles of a banner supporter for supporting the banner, wherein the frame is an elastic body, and its both ends are not connected integrally in a loop shape but separated from each other.

### BRIEF DESCRIPTION OF THE DRAWINGS

FIG. 1 is a perspective view of a conventional banner using a supporting rod.

FIG. 2 is a perspective view showing a conventional banner and a banner holder.

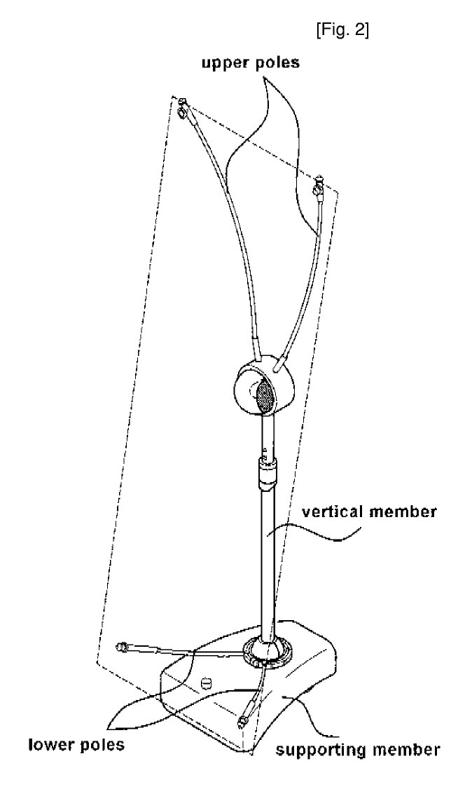

FIG. 3 is a perspective view showing a first preferred embodiment of the present invention.

FIG. 4 is a perspective view showing a second preferred embodiment of the present invention.

FIG. 5 is a perspective view showing a third preferred embodiment of the present invention.

### EXPLANATION OF ESSENTIAL REFERENCE NUMERALS IN DRAWINGS

100: banner

200: frame receiving part

210: first frame receiving part

220: second frame receiving part

300: frame 310: first frame

320: second frame 330: cap

400: pole mounting portion

### BEST MODE FOR CARRYING OUT THE INVENTION

Reference will now be made in detail to the preferred embodiments of the present invention, examples of which are illustrated in the accompanying drawings.

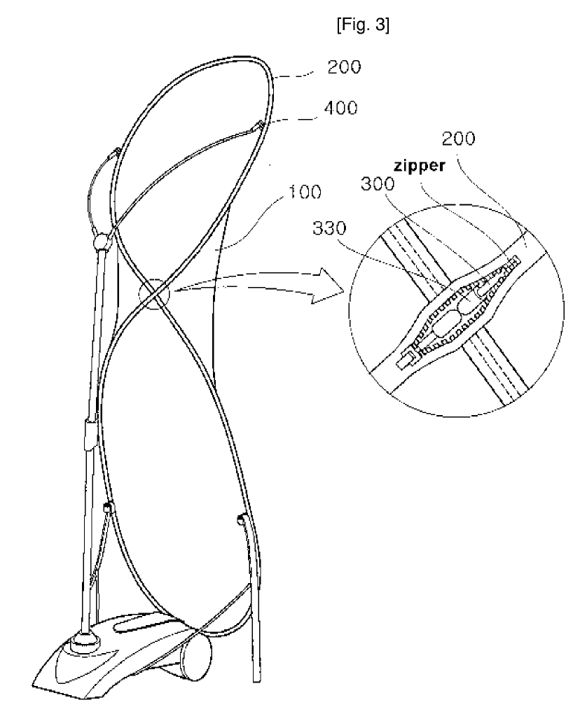

As shown in FIG. 3, a banner equipped with an elastic frame according to the present invention includes a banner 100 on which advertisement is printed, a frame receiving part 200 provided to an edge of the banner 100, a frame 300 inserted into the frame receiving part 200 and forming the exterior shape of the banner 100 using its elasticity, and pole mounting portions 400 disposed on the frame receiving part 200 at a predetermined interval from each other for mounting poles of a banner supporter for supporting the banner 100. The frame 300 is an elastic body, and its both ends are not connected integrally in a loop shape but separated from each other.

### First Embodiment

Referring to FIG. 3, a detailed embodiment of the present invention will be described as follows.

The banner 100 has advertising contents printed thereon, and is mounted on a banner holder so as to be displayed.

The frame receiving part 200 includes a first frame receiving part 210 and a second frame receiving part 220 provided along the edge of the banner 100.

In other words, the first frame receiving part 210 is disposed on the upper edge of the banner 100.

The second frame receiving part 220 is disposed on the lower edge of the banner 100 at a predetermined interval from the first frame receiving part 210.

The first frame receiving part 210 is provided to the upper edge of the banner 100 and the second frame receiving part 220 is provided to the lower edge of the banner 100.

That is, the frame receiving part 200 is provided to the entire edge of the banner 100.

Referring to the drawing, the frame 300 is made of a metal material of a strip type. An end portion of the frame 300 passes the first frame receiving part 210, and crosses the other end portion of the frame 300. After that, the end portion of the frame 300 passes the second frame receiving part 220, and then, meets with the other end portion of the frame 300 again.

Of course, even though both end portions of the frame 300 meet with each other, they are not in a direct contact with each other or not fixed to each other. They are just inserted into the frame receiving part 200 together.

As described above, the frame 300 combined with the first and second frame receiving parts 210 and 220 is generally in the form of the number ‘8’

Moreover, the frame 300 has caps 330 respectively provided to both end portions thereof, and the cap 330 has a curved section at an end portion thereof.

The cap 330 allows the end portions of the frame 300 to be easily inserted into the first and second frame receiving parts 210 and 220.

Not shown in the drawing in detail, but the first frame receiving part 210 for inserting the frame 300 thereinto has a zipper disposed at an entrance thereof, and an exit of the first frame receiving part 210 from which the frame 300 goes out is opened.

In addition, an entrance of the second frame receiving part 220 which the frame 300 of the number ‘8’ shape enters is opened, and the opposite side of the entrance of the second frame receiving part 220 is stopped without any exit.

Therefore, when the frame 300 passes the first frame receiving part 210 and the second frame receiving part 220 and an end of the frame 300 reaches the stopped end of the second frame receiving part 220, a user locks the zipper disposed on the entrance of the first frame receiving part 210. Then, the frame 300 is surrounded with the first and second frame receiving parts 210 and 220 in a state where the frame 300 is twisted in the number ‘8’ shape.

In the above state, poles of the banner supporter are mounted to pole mounting portions 400 disposed on the frame receiving part 200 at a predetermined interval.

Then, the banner 100 is not in a simple plane form but in a three-dimensional form by elasticity of the poles and elasticity of the frame 300 twisted in the number ‘8’ shape, so that people can see the advertising contents not only from the front surface but also from both side surfaces of the banner 100. As a result, the banner 100 according to the present invention can maximize an advertising effect.

The frame 300 is not restricted in the metal material of the strip type shown in the drawing. It is not shown in the drawings, but the frame 300 can be made of complex material of a tube type.

### Second Embodiment

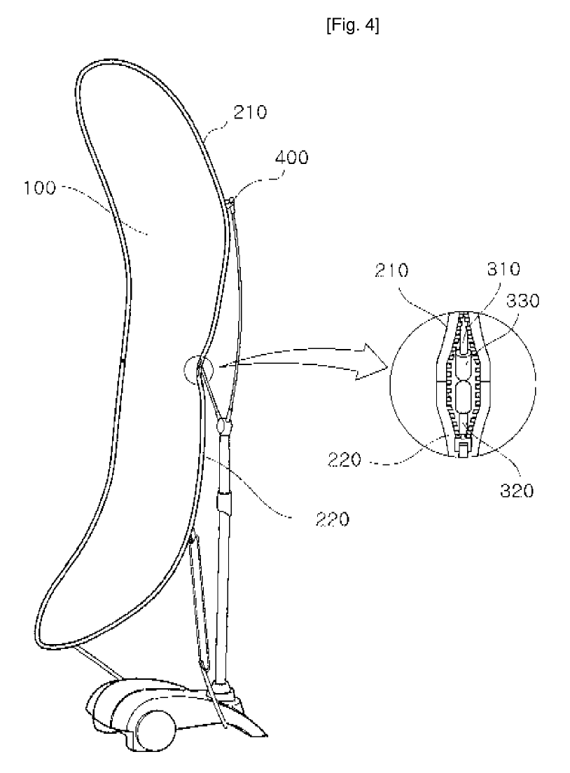

Referring to FIG. 4, a second preferred embodiment of the present invention will be described in detail.

The banner 100 has advertising contents printed thereon, and is mounted on a banner holder so as to be displayed.

The frame receiving part 200 includes a first frame receiving part 210 provided along a side edge of the banner 100 and a second frame receiving part 220 provided along the other side edge of the banner 100, that is, the entire edge of the banner 100 is surrounded with the first frame receiving part 210 and the second frame receiving part 200.

In other words, the first frame receiving part 210 is disposed on the upper part of the banner 100, and the second frame receiving part 220 is disposed on the lower part of the banner 100.

In FIG. 4, the frame 300 includes a first frame 310 inserted and fixed into the first frame receiving part 210, and a second frame 320 inserted and fixed into the second frame receiving part 220.

Furthermore, the frame 300 includes caps 330 respectively having a curved end portion and coupled with both end portions of the first frame 310 and the second frame 320.

Not shown in the drawing in detail, the first frame receiving part 210 for inserting the first frame 310 thereinto has a zipper mounted at an entrance thereof, but does not have an exit for allowing the first frame 310 to go out. The opposite side of the entrance of the first frame receiving part 210 is stopped.

Therefore, when the user locks the zipper disposed on the entrance of the first frame receiving part 210 after inserting the first frame 310, the first frame 310 is combined with the first frame receiving part 210.

Also, the second frame receiving part 220 has a zipper mounted on an entrance for inserting the second frame 320 thereinto. Also, the second frame receiving part 220 does not have an exit for allowing the first frame 310 to go out, and the opposite side of the entrance of the second frame receiving part 220 is stopped.

Therefore, when the user locks the zipper disposed on the entrance of the second frame receiving part 220 after inserting the second frame 320, the second frame 320 is combined with the second frame receiving part 220.

In the above state, poles of the banner supporter are mounted to pole mounting portions 400 disposed on the frame receiving part 200 at a predetermined interval.

Then, the banner 100 is not in a simple plane form but in a three-dimensional form by elasticity of the poles and elasticity of the first frame 310 located at the upper part of the banner 100 and the second frame 320 located at the lower part of the banner 100, so that people can see the advertising contents not only from the front surface but also from both side surfaces of the banner 100. As a result, the banner 100 according to the present invention can maximize an advertising effect.

The frame 300 is not restricted in the metal material of the strip type shown in the drawing. It is not shown in the drawings, but the frame 300 can be made of compound material of a tube type.

### Third Embodiment

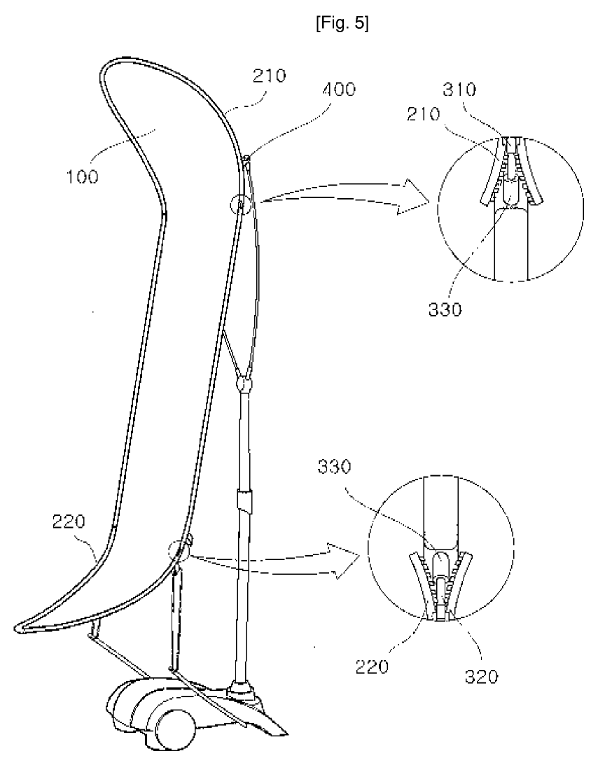

Referring to FIG. 5, a third preferred embodiment of the present invention will be described in detail.

The banner 100 has advertising contents printed thereon, and is mounted on a banner holder so as to be displayed.

The frame receiving part 200 includes a first frame receiving part 210 provided along the upper edge of the banner 100 and a second frame receiving part 220 provided along the lower edge of the banner 100 at a predetermined interval from the first frame receiving part 210.

Therefore, the frame receiving part 200 is not disposed along the entire edge of the banner 100, and a part of the edge of the banner 100 is not provided with the frame receiving part 200.

That is, the first frame receiving part 210 is provided to the upper part of the banner 100 and the second frame receiving part 220 is provided to the lower part of the banner 100, but the central part of the banner 100 is not provided with the frame receiving part 200.

The frame 300 includes a first frame 310 inserted and fixed into the first frame receiving part 210, a second frame 320 inserted and fixed into the second frame receiving part 220, and caps 330 respectively having a curved end portion and coupled with both end portions of the first frame 310 and the second frame 320.

Not shown in the drawing in detail, the first frame receiving part 210 for inserting the first frame 310 thereinto has a zipper mounted at an entrance thereof, but does not have an exit for allowing the first frame 310 to go out. The opposite side of the entrance of the first frame receiving part 210 is stopped.

Therefore, when the user locks the zipper disposed on the entrance of the first frame receiving part 210 after inserting the first frame 310, the first frame 310 is combined with the first frame receiving part 210.

Also, the second frame receiving part 220 has a zipper mounted on an entrance for inserting the second frame 320 thereinto. Also, the second frame receiving part 220 does not have an exit for allowing the first frame 310 to go out, and the opposite side of the entrance of the second frame receiving part 220 is stopped.

Therefore, when the user locks the zipper disposed on the entrance of the second frame receiving part 220 after inserting the second frame 320, the second frame 320 is combined with the second frame receiving part 220.

In the above state, poles of the banner supporter are mounted to pole mounting portions 400 disposed on the frame receiving part 200 at a predetermined interval.

Then, the banner 100 is not in a simple plane form but in a three-dimensional form by elasticity of the poles and elasticity of the first frame 310 located at the upper part of the banner 100 and the second frame 320 located at the lower part of the banner 100, so that people can see the advertising contents not only from the front surface but also from both side surfaces of the banner 100. As a result, the banner 100 according to the present invention can maximize an advertising effect.

The frame 300 is not restricted in the metal material of the strip type shown in the drawing. It is not shown in the drawings, but the frame 300 can be made of compound material of a tube type.

### INDUSTRIAL APPLICABILITY

As described above, the banner equipped with the elastic frame according to the present invention has the following technical effects.

First, the banner equipped with the elastic frame does not need a separate supporting rod fixed and mounted on the ground.

The present invention does not need additional supporter mounted and fixed on the ground but provides a banner structure using a movable banner holder, thereby providing convenience in installation, moving and removal of the banner.

Second, the banner equipped with the elastic frame can be firmly and safely installed by a holder.

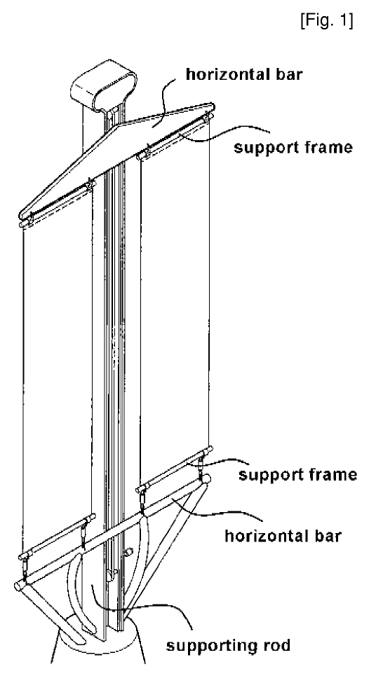

Differently from the conventional banner shown in FIG. 1, the present invention can be firmly and safely installed using elasticity of the banner frame and elasticity of the poles of the banner holder.

Third, the banner equipped with the elastic frame can maintain a three-dimensional form in a state where the banner is installed.

The present invention is not installed in a simple plane form but is installed in the three-dimensional form according to the user s desire and keeps the three-dimensional form, thereby maximizing the advertising effect.

Fourth, the banner equipped with the elastic frame can provide various shapes.

The edge shape of the banner and the location of the frame receiving part are determined and the location of the pole mounting part is selectively determined according to the user s desire, and therefore, the present invention can provide the banner in various forms.

1. A banner equipped with an elastic frame comprising:
a banner printed with advertising contents;
a frame receiving part disposed on the edge of the banner;
a frame inserted into the frame receiving part and forming the exterior shape of the banner using its elasticity; and
pole mounting portions disposed on the frame receiving part at a predetermined interval for mounting poles of a banner supporter for supporting the banner, wherein the frame is an elastic body, and its both ends are not connected integrally in a loop shape but separated from each other.

2. A banner equipped with an elastic frame according to claim 1, wherein the frame is made of a metal material of a strip type or a compound material of a tube type.

3. A banner equipped with an elastic frame according to claim 1, wherein the frame receiving part includes:
a first frame receiving part disposed on a side edge of the banner; and
a second frame receiving part disposed on the other side edge of the banner,
wherein the entire edge of the banner is surrounded with the first and second frame receiving parts, and
wherein the frame is combined into the first frame receiving part and the second frame receiving part in such a way that an end portion of the frame passes the first frame receiving part, crosses the other end portion of the frame, passes the second frame receiving part, and then, meets with the other end portion of the frame again, whereby the frame is in the form of the number ‘8’ shape, and the frame includes caps coupled to both end portions of the frame, each cap having a curved end portion

4. A banner equipped with an elastic frame according to claim 1, wherein the frame receiving part includes:
a first frame receiving part disposed on a side edge of the banner; and
a second frame receiving part disposed on the other side edge of the banner,
wherein the entire edge of the banner is surrounded with the first and second frame receiving parts, and
wherein the frame includes:
a first frame inserted and fixed into the first frame receiving part;
a second frame inserted and fixed into the second frame receiving part; and
caps coupled to both end portions of the first and second frames, each cap having a curved end portion.

5. A banner equipped with an elastic frame according to claim 1, wherein the frame receiving part includes:
a first frame receiving part disposed on a side edge of the banner; and
a second frame receiving part disposed on the other side edge of the banner at a predetermined interval from the first frame receiving part, and
wherein the frame includes:
a first frame inserted and fixed into the first frame receiving part;
a second frame inserted and fixed into the second frame receiving part; and
caps coupled to both end portions of the first and second frames, each cap having a curved end portion.
